(19) United States
(12) Patent Application Publication
(10) Pub. No.: US 2008/0013427 A1
(43) Pub. Date: Jan. 17, 2008

(54) Data recording medium, data playback apparatus and method, data copy recording apparatus and method, and data output apparatus and method

(75) Inventors: Yoichiro Sako, Tokyo (JP); Tomihiro Nakagawa, Tokyo (JP); Shunsuke Furukawa, Tokyo (JP); Kaoru Kijima, Tokyo (JP); Yoshimasa Utsumi, Tokyo (JP); Mitsuru Toriyama, Chiba (JP); Tatsuya Inokuchi, Tokyo (JP); Kazuko Sakurai, Tokyo (JP); Akira Tange, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/900,381

(22) Filed: Sep. 11, 2007

Related U.S. Application Data
(62) Division of application No. 10/145,394, filed on May 14, 2002.

(30) Foreign Application Priority Data
May 14, 2001 (JP) JP2001-143599

(51) Int. Cl. G11B 7/00

(52) U.S. Cl. 369/53.21

(57) ABSTRACT

A recording medium includes at least a recording area in which pieces of content data are recorded, and a lead-in area in a position that is read before the recording area is read. In one of the recording area and the lead-in area, identification information which indicates whether the recording medium is for a rental use is recorded.

### BACKGROUND OF THE INVENTION

1. Field of the Invention

The present invention relates to recording media, recording-medium recording/playback methods, recording-medium recording/playback apparatuses, and data output apparatuses. In particular, the present invention relates to a recording medium on which content data is recorded, an apparatus and method that performs recording to the recording medium or plays back the recording medium, a recording/playback apparatus for the recording medium, and an apparatus and method for outputting the content data.

2. Description of the Related Art

Compact disks (CDs) are known as disk recording media on which digitized audio signals are optically recorded. The CDs each have a diameter of 12 centimeters and a recording capacity of 600 megabytes or greater. The format of the CDs is based on the standard “the Red Book”. The Red book-based format have become applied to a compact-disk read-only memory (CD-ROMs) format, a compact disk recordable (CD-R) format in which data can be written only once, and a compact-disk rewritable (CD-RW) format in which data can be rewritten.

So-called “digital versatile disks or digital video disks (DVDs)” are known as recording media for providing high-picture-quality digital-video signals.

Data recording media such as CDs and DVDs may be not only purchased by consumers but also may be rented at so-called “rental shops”. The former is called a “selling use”, and the latter is called a “rental use”.

It is the present situation that rental-use data recording media can be freely copied similarly to selling-use data recording media. In some cases, there is a possibility that rental-use data recording media are used beyond the range of private copying.

### SUMMARY OF THE INVENTION

It is an object of the present invention to provide a recording medium which solves the above problem.

It is another object of the present invention to provide a playback method for playing back a recording medium which solves the above problem.

It is a further object of the present invention to provide a playback apparatus for a recording medium which solves the above problem.

It is a still further object of the present invention to provide a recording method for a recording medium which solves the above problem.

It is another object of the present invention to provide a recording apparatus for a recording medium which solve the above problem.

It is another object of the present invention to provide a data output method which solves the above problem.

To these ends, according to an aspect of the present invention, a recording medium is provided which includes at least one recording area in which pieces of content data are recorded, and a lead-in area in a position which is read before the at least one recording area is read. Identification information which indicates whether or not the recording medium is for a rental use is recorded in one of the at least one recording area and the lead-in area.

According to another aspect of the present invention, a recording medium playback method for playing back a recording medium is provided. The recording medium includes a first recording area, a second recording area, and a lead-in area in a position being read before the first recording area and the second recording area are read. The recording medium has identification information recorded in one of the first recording area, the second recording area, and the lead-in area. The identification information indicates whether or not the recording medium is for a rental use. The recording medium playback method includes the steps of determining whether or not the identification information is extracted and identified from a signal read from the recording medium, and, when the identification information is identified, restricting the operation of playing back data which is recorded in one of the first recording area and the second recording area.

According to another aspect of the present invention, a recording medium playback apparatus for playing back a recording medium is provided. The recording medium includes a first recording area, a second recording area, and a lead-in area in a position being read before the first recording area and the second recording area are read. The recording medium has identification information recorded in one of the first recording area, the second recording area, and the lead-in area. The identification information indicates whether or not the recording medium is for a rental use. The recording medium playback apparatus includes a head unit which scans the recording medium, a decoding processor which performs decoding processing on a signal output from the head unit, an identifying unit which extracts the identification information from the output signal from the head unit, a playback processor which is supplied with data output from the decoding processor and which performs playback processing on the supplied output data, a switching unit which is controlled by a signal output from the identifying unit to perform switching as to whether or not the output data from the decoding processor is supplied to the playback processor, and which is controlled, when the identification information is identified by the identifying unit, to supply the output data from the decoding processor to the playback processor and a controller which is supplied with the output signal from the identifying unit, which controls, based on the output signal supplied from the identifying unit, the operation of the playback processor, and which performs, when being supplied with an output signal indicating that the identification information is identified by the identifying unit, restriction of the playback processing by the playback processor on the output data from the decoding processor.

According to another aspect of the present invention, a method for recording to a recording medium which includes the steps of, when supplied content data is recorded on the recording medium, identifying identification information indicating whether or not the content data is for a rental use, and, when the identification information is identified, restricting the operation of recording the content data on the recording medium.

According to another aspect of the present invention, a recording apparatus for a recording medium is provided which includes an identifying unit which identifies identification information indicating whether or not supplied content data is for a rental use, a signal processor which is supplied with the content data and which performs signal processing for recording on the supplied content data, and a switching unit which is controlled by a signal output from the identifying unit to perform switching as to whether or not the content data is supplied to the signal processor and which supplies the content data to the signal processor when the identification information is not identified by the identifying unit.

According to another aspect of the present invention, a recording apparatus for a recording medium is provided which includes an identifying unit for identifying identification information indicating whether or not supplied content data is for a rental use, a controller which is supplied with a signal output from the identifying unit, and which performs, when the identification information is identified, based on the output signal from the identifying unit, recording-restricting processing on the content data, and a signal processor which is supplied with data output from the controller and which performs signal processing for recording on the supplied output data.

According to another aspect of the present invention, a recording apparatus for a recording medium is provided which includes an identifying unit for identifying identification information indicating whether or not supplied content data is for a rental use, a signal processor which is supplied with the content data and which performs signal processing for recording on the supplied content data, and a controller which is supplied with a signal output from the identifying unit and which performs, when the identification information is identified, based on the output signal from the identifying unit, control of a recording speed for recording the content data on the recording medium.

According to another aspect of the present invention, a data output method is provided which includes the steps of identifying identification information indicating whether or not supplied content data is for a rental use, and selecting, based on the result of the identifying step, an output format for the content data.

### BRIEF DESCRIPTION OF THE DRAWINGS

FIG. 1 is a perspective view showing an optical disk as a recording medium according to an embodiment of the present invention;

FIG. 2 is an illustration of an example of a recording format for rental ID data;

FIG. 3 is a block diagram showing a process for producing an optical disk;

FIG. 4 is a block diagram showing an optical disk cutting apparatus;

FIG. 5 is a block diagram showing an optical disk playback apparatus according to an embodiment of the present invention;

FIG. 6 is a flowchart showing a first specific example of a playback restricting process which prohibits outputting of a playback signal and which is performed by the optical disk playback apparatus;

FIG. 7 is a flowchart showing a second specific example of a playback restricting process which deteriorates the sound quality of a playback output from an outer recording area and which is performed by the optical disk playback apparatus;

FIG. 8 is a block diagram showing a data copy recording apparatus according to an embodiment of the present invention;

FIG. 9 is a block diagram showing another data copy recording apparatus;

FIG. 10 is a block diagram showing another data copy recording apparatus; and

FIG. 11 is a block diagram showing a data output apparatus according to an embodiment of the present invention.

### DESCRIPTION OF THE PREFERRED EMBODIMENTS

Embodiments of the present invention are described below with reference to the accompanying drawings.

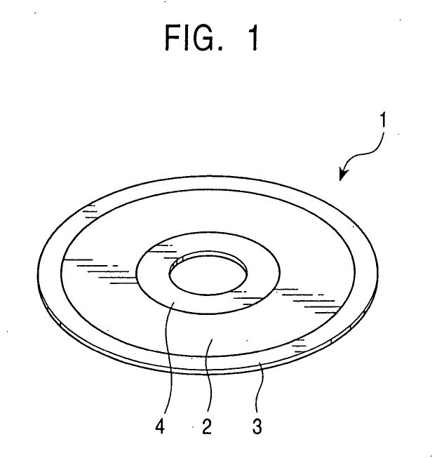

First, an optical disk according to an embodiment of the present invention is described with reference to FIG. 1. On an optical disk 1, digital works (digital content) such as music are recorded in an inner circumferential recording area 2 and an outer circumferential recording area 3 at different recording densities.

The optical disk 1 has a diameter of 12 centimeters, and a central aperture formed in the center which is used when the optical disk 1 is loaded on a turntable of an optical disk playback apparatus (described later). The optical disk 1 consists of a substrate made of a light-transmissive resin, a reflection layer which is formed on one surface of the substrate and which is made of metal such as aluminum, and a protection layer for protecting the reflection layer. On the one surface of the substrate of the optical disk 1, pits based on pieces of data are recorded. The pits are covered with the reflection layer.

As FIG. 1 shows, in the inner recording area 2 as a first recording area, audio data is recorded as recorded data, that is, content data, in a format compatible with a so-called “compact disk” format, for example, in the form of 16-bit linear pulse-code-modulated (PCM) signals. In the inner recording area 2, tracks formed by a plurality of pits based on audio data are spirally formed at a track pitch of 1.6 microns so that compatibility with, for example, a compact disk, can be established. In the outer area 3 as a second recording area, data is recorded, having a recording density higher than that of the inner recording area 2. For example, in the outer recording area 3, tracks formed by a plurality of pits based on data are spirally formed at a track pitch smaller than 1.6 microns. The data recorded in the outer recording area 3 is data generated by encrypting, for example, the audio data recorded in the inner recording area 2. As is clear, the data recorded in the outer recording area 3 may be content data different from the content data recorded in the inner recording area 2. Each of the inner recording area 2 and the outer recording area 3 has a lead-in area and a lead-out area. The inner recording area 2 and the outer recording area 3 are separated by a mirror area, that is, a non-recording area. The data recorded in the inner recording area 2 is not limited to audio data that is compatible with the compact disk, but may be data based on a format that is compatible with a so-called “CD-ROM”, for example, text data, etc.

The data recorded as digital data in the inner recording area 2 and the data recorded as digital data in the outer recording area 3 are physically nonconsecutive data. The outer recording area 3 is used as a restriction area that restricts playback and/or copying of accessed data in a case in which the computer device 1 is rented.

On a side inner than the inner recording area 2, that is, in a position that is read prior to the inner recording area 2 and the outer recording area 3, a table-of-contents (TOC)/lead-in area 4 is formed which contains list data including identification information indicating whether the optical disk 1 is used for a rental use. In the present invention, identifying information that represents a rental use is referred to as “rental ID data”, and identification information that represents not a rental use but a purchase use is referred to as “selling ID data”. In the following description of the present invention, only rental ID data is used as one to be detected/extracted. Needless to say, the TOC/lead-in area 4 contains also medium-identification data indicating whether the optical disk 1 has the inner recording area 2 and the outer recording area 3.

When rental ID data in the TOC/lead-in area 4 is detected/extracted by a playback apparatus for playing back the optical disk 1, the playback apparatus restricts, based on the result of the detection/extraction, the operation or process of playing back the outer recording area 3 that is used as a restriction area. When rental ID data is detected/extracted by a data output apparatus for outputting content data read from the optical disk 1, the data output apparatus restricts the operation or process of outputting content data. When rental ID data is detected/extracted from data read from the TOC/lead-in area 4 of the optical disk 1 by a data copy recording apparatus for copying and recording content data, the recording apparatus restricts the process of copying and recording content data. Specific examples of the above data playback apparatus, the above data output apparatus, and the above data copy recording apparatus are described later.

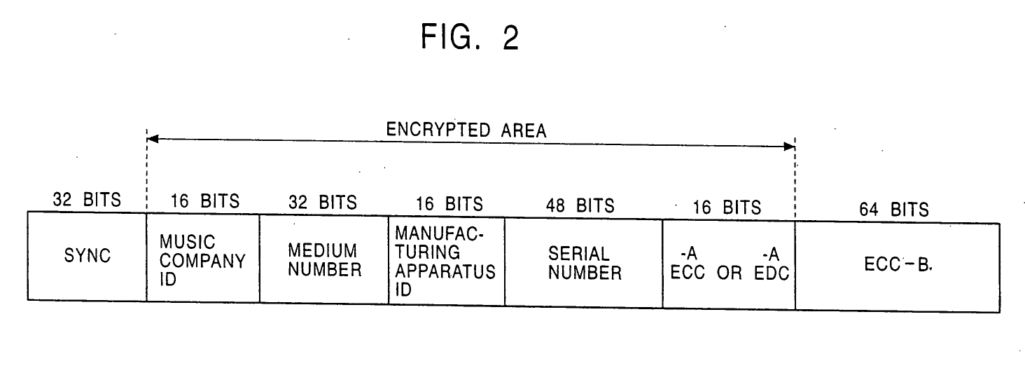

FIG. 2 shows an example of a recording format for rental ID data. As FIG. 2 shows, the first portion of the rental ID data, for example, first 32 bits are used as a synchronization (SYNC) portion, and a portion following the synchronization portion is used as an encrypted area in which the main part of data representing rental ID data is data-converted (specifically encrypted) and is recorded. The encrypted area has a total of 128 bits, for example, 16-bit data representing a music company (in general, a content production and/or distribution company) ID, 32-bit medium-number data, 16-bit manufacturing-apparatus ID data, 48-bit serial-number data, and 16-bit data representing an error correcting code (ECC-A) or an error detecting code (ECD-A). The 48-bit serial-number data is the main part of rental ID data, and can be freely set by the music company. Following the encrypted area, for example, a 64-bit error correcting code (ECC-B) is added, and the rental ID data has a total of 224 bits as a whole, including the synchronization portion at the top.

The 16-bit ECC-A or EDC-A is generated by a cyclic redundancy check (CRC) in which
g(x)=x16+x12+x5+1
is used as a creation polynomial expression. The creation polynomial expression may be arbitrarily set by the music company. This can ensure that random bit arrangements can be excluded. This code differs in purpose from the 64-bit ECC-B. It is used not for its original purpose of error correction or error detection, but as data for authenticating each ID, that is, rental ID data. In other words, it can be determined whether or not rental ID data is detected.

For the 64-bit ECC-B, for example, the creation polynomial expression:
f(x)=x8+x4+x3+x2+1
is used, and the (24, 16, 9) Reed Solomon-product code can be used in which, when f(( )=0,
G(x)=(x+1)(x+α)(x+α2) . . . (x+α7)
The code has a correction ability that can perform 4-byte detection correction or 8-byte elimination correction.

In summary, at least two error correcting codes or error detecting codes are used. One is used for its original purpose of error correction or error detection, and the other is used for authenticating rental ID data.

In the above encrypted area, rental ID data itself is protected by encrypting, for example, 128-bit data, in a public key system based on the Rivest-Shamir-Aldleman (RSA) algorithm, or in a common key cryptosystem based on the Data Encryption Standard.

FIG. 2 simply shows an example of the rental ID data format. The number and arrangement of bits in each area, etc., can be arbitrarily set, and the types of the areas may be increased or reduced.

By way of example, when rental ID data is detected/extracted, the playback apparatus and/or the copy recording apparatus (described later) can prohibit playback and/or copying of digital content data recorded in the outer recording area 3. When detecting rental ID data, the playback apparatus and/or the copy recording apparatus (described later) can prohibit playback and/or copying quality of digital content data recorded in the outer recording area 3. When detecting rental ID data, the copy recording apparatus can limit a speed for copying digital content data read from the outer recording area 3. The copy recording apparatus can also limit the number of copies of the digital content data read from the outer recording area 3 and can prohibit copying in the digital form of the digital content data.

On the optical disk 1, the recording density of the inner recording area 2 and the recording density of the outer recording area 3 are set to differ from each other. Alternatively, as described below, by setting the recording densities of the inner recording area 2 and the outer recording area 3 to be identical to each other, or to differ as described above, audio data and its additional data may be separately recorded in the inner recording area 2 and the outer recording area 3.

For example, based on the CD or DVD format, recording data is recorded as first data in one recording area, and its additional data is recorded as second data in the other recording area. Specifically, based on the CD or DVD format, first data as content data is recorded in the inner recording area 2, and second data as additional data for the first data is recorded in the outer recording area 3.

The second data includes compressed audio data and image data, or text data of lyrics and explanation. The specific contents of the second data include data on, for example, a poster, a cover jacket, lyrics, linear notes, an interview article, a new song guide, a lottery for a concert, viewing a network live program, karaoke, and graffiti.

Accordingly, the optical disk 1 can be designed so that content to be played back can be differentiated between a rental use and a selling use. This makes it possible to give preferential treatment to a person who actually purchases the optical disk 1. For example, when the optical disk 1 is used for a rental use, an area that cannot be played back is formed, or a restriction area is formed in which sound quality deteriorates, or additional data such as text and a cover jacket photograph cannot be played back. For a person who actually purchases the optical disk 1, in addition to provision of the optical disk 1 with the function of normally playing back content data as first data, the optical disk 1 is designed so that the additional information as second data, for example, text and cover-jacket-photograph data, can be played back.

Control of copying of data read from the optical disk 1 can be differentiated between a rental-use optical disk and a selling-use optical disk. Since copying of data read from the rental-use optical disk exceeds the range of private copying, by restricting data copying in the case of the rental-use optical disk, the use of the rental-use optical disk can be limited to its original use. For example, for the rental-use optical disk, copying of data read from the optical disk can be limited only to copying of analog signals that are generated by converting the read data, and copying or recording in which data read from the optical disk is digitally output at high speed and is recorded on another recording medium is prohibited. Alternatively, data that is read from a predetermined area (or predetermined content) can be set so as not to be copied.

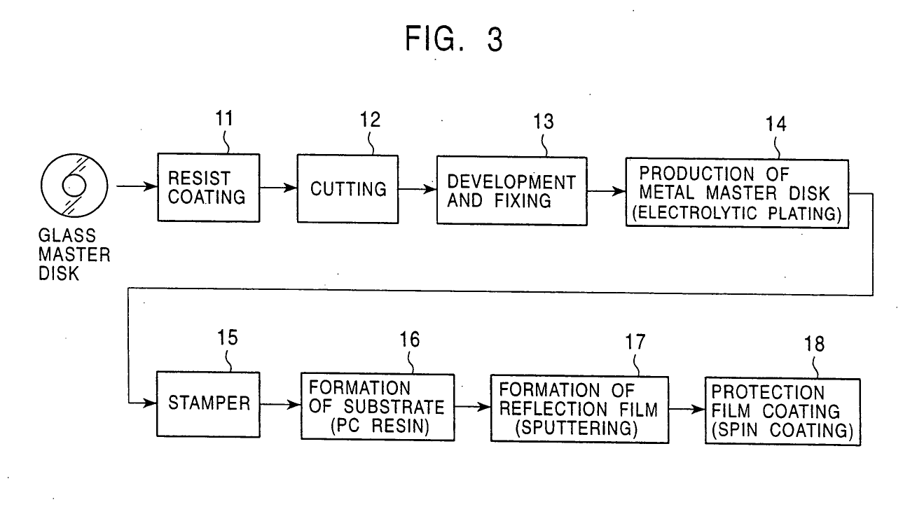

Next, a process for producing the optical disk 1, to which rental ID data is added as described above, is described below with reference to FIG. 3.

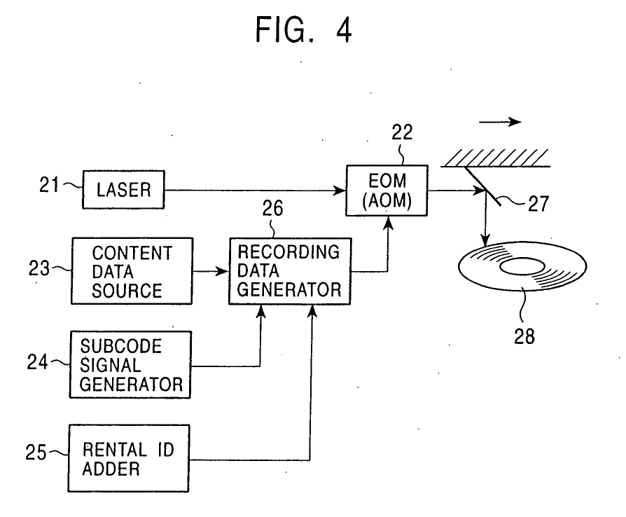

Referring to FIG. 3, in a resist coating step 11, a glass master disk (glass master disk 28 shown in FIG. 4) is coated with a photoresist. In a cutting step 12, by using a laser cutting apparatus (described later) as shown in FIG. 4, laser cutting of the glass master disk is performed. In a development and fixing step 13, the photoresist on the glass master disk is developed and fixed. After that, in a step 14 for production of metal master disk, by electrolytically plating the glass master disk, a metal master disk is formed. In a stamper step 15, a stamper based on the metal master disk is formed. In a step 16 for the formation of substrate, by using the formed stamper and a method such as injection molding, a substrate which is made of a transparent resin such as polycarbonate or acryl and which has pits formed on one surface is formed. In a step 17 for the formation of reflection film, by performing sputtering, a reflection film is formed on the pit-formed surface of the transparent resin substrate. Material for forming a recordable, special reflection film is used as a target for the sputtering. For example, material is used which is a recording material mainly consisting of silver or a recording material mainly consisting of aluminum and which can form a special reflection film having a reflection factor similar to that of the conventional CD or DVD or a reflection factor enabling reading by using a conventional optical head. The reflection factor of the special reflection film is changed by laser radiation having power larger than that of playback laser radiation. In a step 18 for protection film coating, by performing spin coating using UV curable resin, a protection film is formed on the reflection film. In the next step for recording a unique ID data, by emitting a laser beam onto the reflection film, rental ID data as the unique ID data is recorded.

Next, an example of a cutting apparatus for use in the cutting step 12 in FIG. 3 is briefly described with reference to FIG. 4.

A laser such as a He—Ne gas laser or Ar gas laser is used as a laser source 21. A laser beam from the laser source 21 is modulated by an optical modulator 22. The laser beam modulated by the optical modulator 22 is reflected by a mirror 27 for radial shifting, and is converged and emitted onto the disk 28 (the glass master disk coated with the resist) by an objective lens (not shown). The optical modulator 22 has an electrooptical modulator (EOM) in which a reflection factor is changed by an applied voltage. Instead of the EOM, an acoustooptic modulator (AOM) may be used. For the CD, signals from a content data source 23, a subcode signal generator 24, and a rental ID adder 25 are sent to a recording data generator 26, and a signal generated by the recording data generator 26 is supplied to the optical modulator 22.

Although a case in which rental ID data is recorded in the TOC/lead-in area 4 on the optical disk 1 has been described, the rental ID data may be recorded in the header portion of digital content data recorded in the outer recording area 3. Also, by using a watermarking technology, the rental ID data may be recorded as a watermark such that it is embedded in data recorded in the inner recording area 2 or the outer recording area 3.

The watermark based on the rental ID data is embedded in a portion in which the average spectrum energy of content data is large, by using a spread spectrum technology. Specifically, only when the average spectrum energy of each sample block of content data is larger than a level reflecting the spectrum energy of a specific interval does a watermark encoder (not shown) embed rental ID data in content data in the form of a spread spectrum signal. The spread spectrum signal is generated by using PN series random numbers PN to perform a spread spectrum process on rental ID data in order to protect and manage the rental ID data.

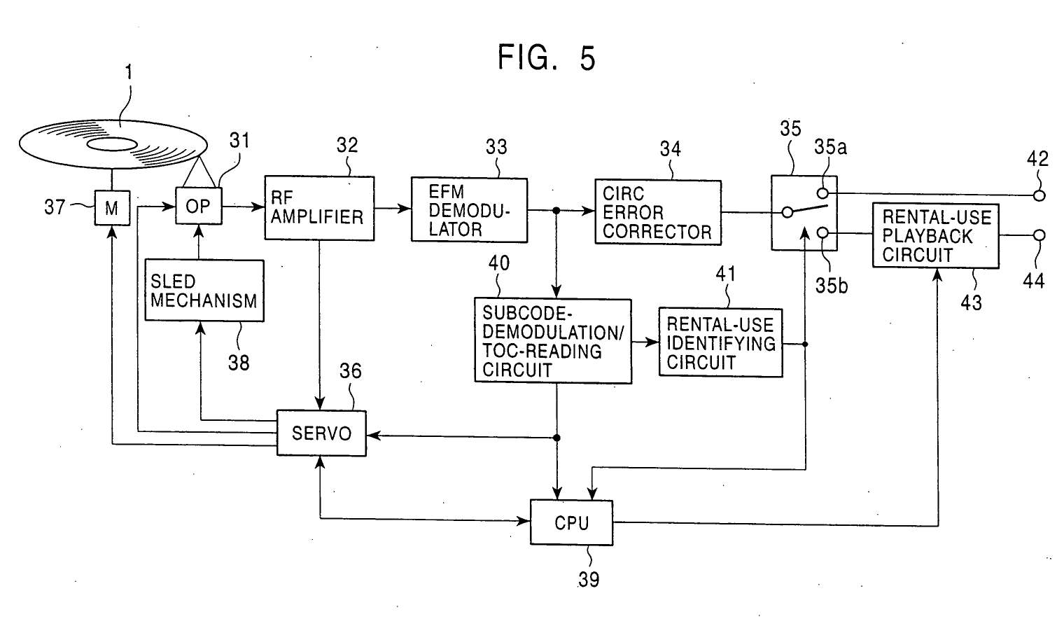

Next, an optical disk playback apparatus as a data playback apparatus and method according to an embodiment of the present invention is described below with reference to FIG. 5.

The optical disk playback apparatus includes an optical pickup 37 which reads digital data including each piece of digital content data from the inner recording area 2 and the outer recording area 3 by emitting a laser beam onto the optical disk 1 shown in FIG. 1, and outputs the read data as a read signal, a decoding processor that performs a decoding process on the read signal, a subcode-demodulation/TOC-reading circuit 40 that performs demodulation of a subcode from the read signal or reading of a TOC-information signal from the read signal, and a rental-use identifying circuit 41 that identifies rental ID data indicating whether or not data output from the subcode-demodulation/TOC-reading circuit 40 is for a rental use. The optical disk 1 is scanned with the optical pickup 31 such that the optical pickup 31 is moved from an inner circumferential position to an outer circumferential position by a sled mechanism (described later).

The decoding processor includes a radio frequency (RF) amplifier 32, an eight-to-fourteen-modulation (EFM) demodulator 33, and a cross-interleave-Reed-Solomon-code (CIRC) error corrector 34.

The RF amplifier 32 captures a signal recorded on the optical disk 1 by digitizing the read signal from the optical pickup 31, and sends the digitized signal to the EFM demodulator 33. The RF amplifier 32 separates the read signal from the optical pickup 31, generates signals such as a tracking-error signal and a focus-error signal, and sends the generated signals to a servo circuit 36.

The EFM demodulator 33 performs a process for demodulating content data modulated (specifically, eight-to-fourteen-modulated) when it is recorded on the optical disk 1, on the digitized signal supplied from the RF amplifier 32. In this embodiment, the EFM demodulator 33 performs an EFM demodulation process. Digital data from the EFM demodulation circuit 33 is sent to the CIRC error corrector 34 and the subcode-demodulation/TOC-reading circuit 40.

Based on an error correcting code added to each piece of content data when it is recorded on the optical disk 1, the CIRC error corrector 34 performs error-detecting and error-correcting processes on the read signal from the optical disk 1 (on the digital data from the EFM demodulator 33 in this embodiment).

The optical disk playback apparatus also includes a spindle motor 37 for rotating the optical disk 1 at, for example, a constant linear velocity, and the servo circuit 36 for controlling the rotation of the spindle motor 37 and sled, focusing, and tracking operations to the optical disk 1 of the optical pickup 31.

The optical disk playback apparatus also includes a central processing unit (CPU) 39 formed by a microcomputer, and a switching circuit 35 that, based on an identification result from the rental-use identifying circuit 41, switches between directly supplying an output terminal 42 and supplying a rental-use playback circuit 43 (described later) with output data that is error-corrected by the CIRC error corrector 34. The CPU 39 is supplied with subcode data and TOC data from the subcode-demodulation/TOC-reading circuit 40. Based on the supplied subcode data and TOC data, the CPU 39 controls the access operation of the optical pickup 31. The CPU 39 is a control unit that controls the operations of components constituting the optical disk playback apparatus, and is connected to an operation unit (not shown) having a playback start button, etc.

Since the optical disk playback apparatus has the above circuits, it briefly operates as follows:

First, the optical disk 1 is rotated at a constant linear velocity by the spindle motor 37. From the optical disk 1 being rotated, data recorded in an optically readable form is read and supplied as a read signal to the RF amplifier 32 by the optical pickup 31. The read signal is digitized and supplied to the EFM demodulator 33 by the RF amplifier 32. The RF amplifier 32 supplies the servo circuit 36 with the signals generated based on the read signal from the optical pickup 31, such as the tracking-error signal and the focusing-error signal.

The servo circuit 36 generates a tracking servo signal and a focusing servo signal based on the supplied tracking-error signal and focusing-error signal, and sends the generated tracking servo signal and focusing servo signal to an actuator for the objective lens of the optical pickup 31. The servo circuit 36 also sends a sled servo signal to a feeding motor of the sled mechanism 38 for radially moving the optical pickup 31. Between the servo circuit 36 and the CPU 39, commands, and control data, etc., are transmitted and received. For example, when an access operation is performed by radially moving the optical pickup 31 on the optical disk 1, the CPU 39 sends a command to control the servo circuit 36 to terminate the tracking servo operation.

The digitized signal supplied from the RF amplifier 32 is EFM-demodulated and sent to the subcode-demodulation/TOC-reading circuit 40 by the EFM demodulator 33. The EFM demodulator 33 performs an error detecting process and an error correcting process on digital data from the EFM demodulator 33, and supplies the processed data to the switching circuit 35.

From the digital data as the EFM-demodulated output data from the EFM demodulator 33, the subcode-demodulation/TOC-reading circuit 40 demodulates a subcode or reads a TOC, and supplies the demodulated output or the read output data to the rental-use identifying circuit 41.

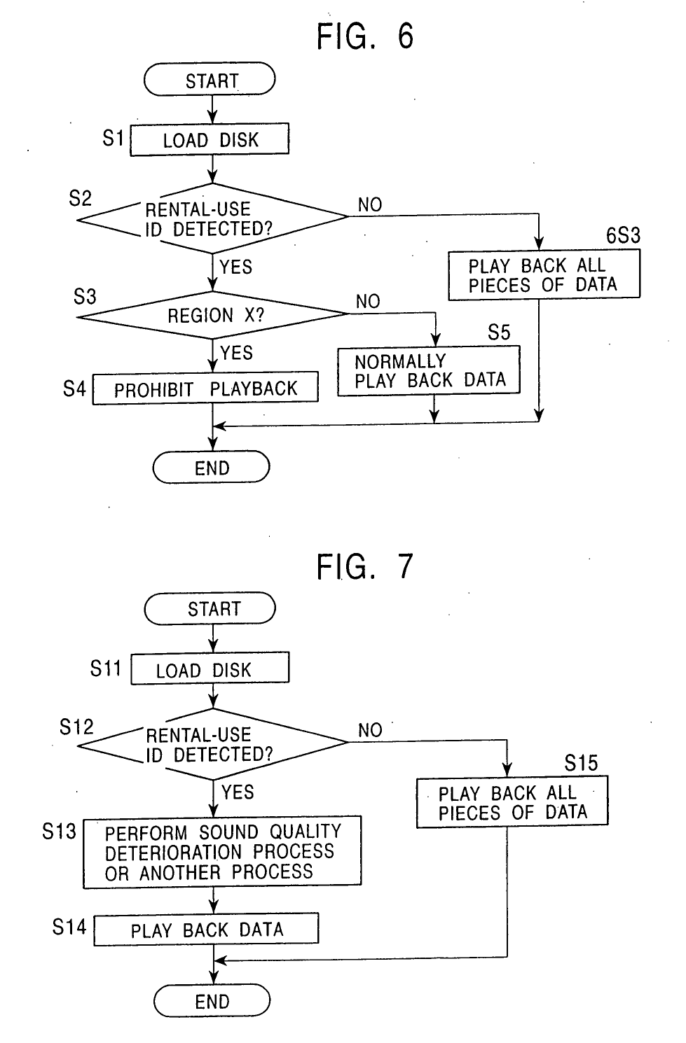

The rental-use identifying circuit 41 identifies rental ID data from the data output from the subcode-demodulation/TOC-reading circuit 40. When identifying rental ID data, the rental-use playback circuit 41 controls the switching circuit 35 to connects its selector to a lower selection terminal 35b, whereby the output data from the CIRC error corrector 34 is supplied to the rental-use playback circuit 43. The output data from the rental-use identifying circuit 41, that is, data based on the result of extraction or identifying of rental ID data is supplied to the CPU 39. Based on the output data from the rental-use identifying circuit 41, the CPU 39 executes a control operation shown in FIG. 6 and thereafter.

Based on the rental ID data identified by the rental-use identifying circuit 41, the rental-use playback circuit 43 restricts the operation or process of playing back playback data based on the output data from the CIRC error corrector 34, that is, the signal read from the optical disk 1. Specifically, the rental-use identifying circuit 41 identifies rental ID data and controls the switching circuit 35 to connect its selector to the lower selection terminal 35b, whereby the rental-use playback circuit 43 controls the operation of playing back playback data based on the signal read from the outer recording area 3 on the optical disk 1. At this time, the result of identifying or not identifying of rental ID data does not affect the operation of playing back playback data based on the signal read from the optical disk 1. Also, when the rental-use identifying circuit 41 does not identify rental ID data, in other words, when the optical disk 1 is not for a rental use but for a selling use, the operation of playing back playback data based on the signal read from the inner recording area 2 and the outer recording area 3 on the optical disk 1 is not restricted. When the rental-use identifying circuit 41 does not perform extraction and identifying of rental ID data from the output data from the subcode-demodulation/TOC-reading circuit 40, it controls the switching circuit 35 to connect its selector to an upper selection terminal 35a, so that the output data from the CIRC error corrector 34 is output from an output terminal 42.

Next, a specific example of the playback restricting operation performed when the rental-use identifying circuit 41 has identified rental ID data is described below.

By using the flowchart shown in FIG. 6, an output prohibiting process is described below in which, when rental ID data is extracted from the optical disk 1 and is identified by the rental-use identifying circuit 41 of the optical disk playback apparatus, the rental-use playback circuit 43 is controlled to perform a process of prohibiting the outputting of playback data based on the signal read from the outer recording area 3 on the optical disk 1. In the following description, the control operation based on the flowchart in FIG. 6 is performed such that the CPU 39 controls, based on the result of extraction and identifying which is supplied from the rental-use identifying circuit 41, the operation of the rental-use playback circuit 43.

In step S1, when the optical disk 1 is loaded into the optical disk playback apparatus by a user thereof, for example, when the playback start button (not shown) is operated by the user, a command from the CPU 39 controls the spindle motor 37 to start to rotate the optical disk 1 at a constant linear velocity, and the optical pickup 31 accesses the TOC/lead-in area 4, so that a signal read by the optical pickup 31 is supplied to the subcode-demodulation/TOC-reading circuit 40 via the RF amplifier 32 and the EFM demodulator 33.

When the rental-use identifying circuit 41 performs a process for extracting rental ID data from output data supplied from the subcode-demodulation/TOC-reading circuit 40, in other words, if the operation has determined that rental ID data is detected (“YES” in step S2), the process proceeds to step S3.

In step S3, based on both TOC data supplied from the subcode-demodulation/TOC-reading circuit 40 and subcode data or address data based on the read signal from the optical pickup 31, the CPU 39 determines whether or not an area being accessed by the optical pickup 31 is region X, that is, whether or not the area is the outer recording area 3 in this embodiment. If the area is region X (the outer recording area 3), the CPU 39 proceeds to step S4, and hinders or prohibits the outer recording area 3 from being played back. In other words, playback data based on the signal read from the outer recording area 3, that is, the output data from the CIRC error detector 34 is supplied to the rental-use playback circuit 43 via the switching circuit 35, and the rental-use playback circuit 43 hinders or prohibits subsequent playback operation or signal processing for playback. In step S31, if the CPU 39 has determined that the area being accessed by the optical pickup 31 is not region X, that is, if the area is the inner recording area 2, the CPU 39 proceeds to step S5, and performs a normal playback operation.

In step S2, if the CPU 39 has determined that rental ID data cannot be extracted or identified, it finds that the loaded optical disk 1 is not for a rental use but for a selling use, and proceeds to step S6.

In step S6, the switching circuit 35 connects its selector to the upper selection terminal 35a, so that playback data based on the signal read from the inner recording area 2 and the outer recording area 3, that is, all pieces of the output data from the CIRC error corrector 34 are supplied to the output terminal 42 and are output therefrom.

Second, a process which deteriorates playback data based on the signal read from the outer recording area 3 and which is executed by the rental-use playback circuit 43 when the rental-use identifying circuit 41 has extracted and identified rental ID data from the optical disk 1 is described below with reference to the flowchart shown in FIG. 7.

In step S11, when the optical disk 1 is loaded into the optical disk playback apparatus by the user, for example, similarly to step S1 in FIG. 6, the playback start button (not shown) is operated by the user, the spindle motor 37 is started to rotate the optical disk 1 at a constant linear velocity, and the optical pickup 31 is moved by the sled mechanism 38 to access the TOC/lead-in area 4 on the optical disk 1, so that a signal read from the optical disk 1 is supplied to the subcode-demodulation/TOC-reading circuit 40 via the RF amplifier 32 and the EFM demodulator 33.

When the rental-use identifying circuit 41 has extracted and identified rental ID data by performing processing for extracting and identifying rental ID data from the output data from the subcode-demodulation/TOC-reading circuit 40, that is, if the result of determination in step S12 is affirmative, the process proceeds to step S13.

In step S13, the rental-use playback circuit 43 performs a sound quality deterioration process on the playback data based on the signal read from the outer recording area 3, that is, the output data from the CIRC error corrector 34. After that, the data, obtained by performing the sound quality deterioration process on the playback data based on the signal read from the outer recording area 3, is output from the output terminal 44. The sound quality deterioration process that is performed in step S13 by the rental-use playback circuit 43 includes, for example, a process that deletes some of the lower bits of the output data from the CIRC error corrector 34, and a process that reduces the sampling rate. However, another process may be used if it makes the user feel deterioration in sound quality when the user listens.

In step S12, if the rental-use identifying circuit 41 has determined that it cannot extract or identify rental ID data, it finds that the loaded optical disk 1 is not for a rental use but for a selling use. In step S15, the switching circuit 35 connects its selector to the upper selection terminal 35a, so that all pieces of the playback data based on the signals read from the inner recording area 2 and the outer recording area 3 are output from the output terminal 42.

Also, as described above, when additional information corresponding to audio data as content data recorded in the inner recording area 2, such as a poster, a cover jacket, lyrics, linear notes, an interview article, a new song guide, a lottery for a concert, viewing a network live program, karaoke, and graffiti, is recorded in the outer recording area 3, if rental ID data is extracted and identified in step S12, a process that hinders or prohibits the additional information from being played back may be performed instead of a sound quality deterioration process as in step S13.

Although a case in which the optical disk playback apparatus identifies rental ID data after extracting it from the TOC/lead-in area 4 has been described, it is possible that, as described above, rental ID data be recorded in the header portion of the digital content data recorded in the outer recording area 3, and the recorded rental ID data may be extracted and identified. Also, rental ID data that is embedded as a watermark may be extracted. Each of the control operations shown in FIGS. 6 and 7 may be executed when the CPU 39 reads medium-identification data from the data supplied from the subcode-demodulation/TOC-reading circuit 40, and the loaded optical disk 1 is identified as an optical disk having the inner recording area 2 and the outer recording area 3 as shown in FIG. 1.

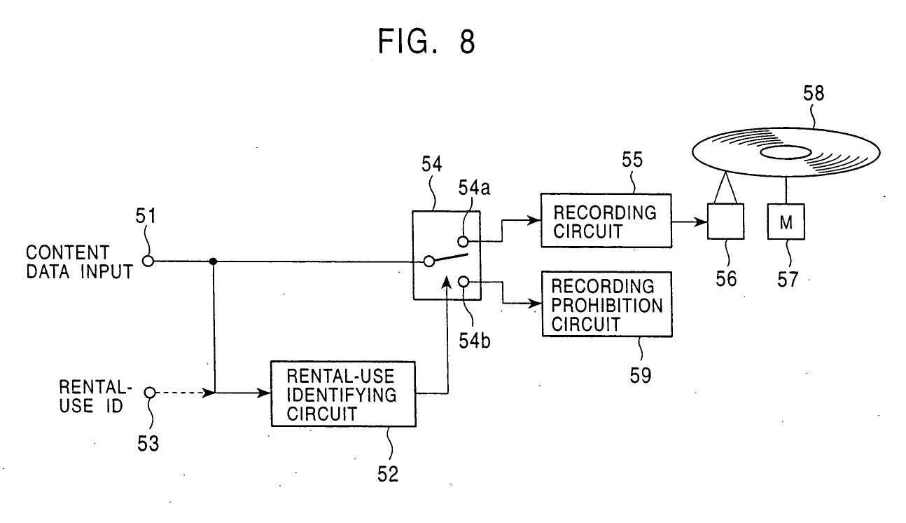

Next, a data copy recording apparatus according to an embodiment of the present invention is described below with reference to FIG. 8.

The data copy recording apparatus includes a rental-use identifying circuit 52 that determines whether input digital content data is identified as rental-use content data. Based on the identifying result obtained by the rental-use identifying circuit 52 prohibits a process for copying and recording the input digital content data. Accordingly, the data copy recording apparatus includes a recording prohibition circuit 59 that, based on the identifying result obtained by the rental-use identifying circuit 52, prohibits the copying-and-recording process.

As FIG. 8 shows, the data copy recording apparatus also includes a recording circuit 55 that performs recording processes (such as an error correcting process and a modulation process) on content data input from an input terminal 51 without performing recording-restricting processing, a switching circuit 54 that, based on the identifying result from the rental-use identifying circuit 52, switches between supplying the recording circuit 55 and supplying the recording prohibition circuit 59 with the content data input from the input terminal 51, an optical head 56 which is supplied with the data processed by the recording circuit 55 and which emits a laser beam based on the supplied data onto an optical disk 58, and a spindle motor 57 that rotates the optical disk 58 at a constant linear or angular velocity. The optical disk 58 is recordable and may be any one of a recordable optical disk such as a CD-R, a phase-change optical disk such as a CD-RW, and other optical disks in accordance with other recording formats.

The operation of the data copy recording apparatus in FIG. 8 is described below.

The rental-use identifying circuit 52 extracts and identifies rental ID data that is added to or superimposed on the content data input from the input terminal 51. When the rental ID data is identified, the rental-use identifying circuit 52 controls the switching circuit 52 to connect its selector to a lower selection terminal 54b, so that the input content data is supplied to the recording prohibition circuit 59. The recording prohibition circuit 59 prohibits recording of the input content data to the optical disk 58.

When the rental-use identifying circuit 52 cannot extract and identify rental ID data, in other words, when the input content data is identified not as rental-use content data but as selling-use content data, the rental-use identifying circuit 52 supplies the input content data to the recording circuit 55 by controlling the switching circuit 52 to connect its selector to an upper selection terminal 54a. The recording circuit 55 performs predetermined processing (e.g., a modulation process, an error correcting and encoding process, etc.) on the supplied content data, and supplies the processed data as recording data to the optical head 56. The optical head 56 emits a laser beam based on the recording data onto the optical disk 58, so that a copy of the content data is recorded on the optical disk 58.

The rental ID data may be directly supplied from the input terminal 53 to the rental-use identifying circuit 52.

Accordingly, the data copy recording apparatus in FIG. 8 can prohibit content data having rental ID data added thereto or superimposed thereon from being copied to the optical disk 58. This can thus reduce conducts exceeding private copying.

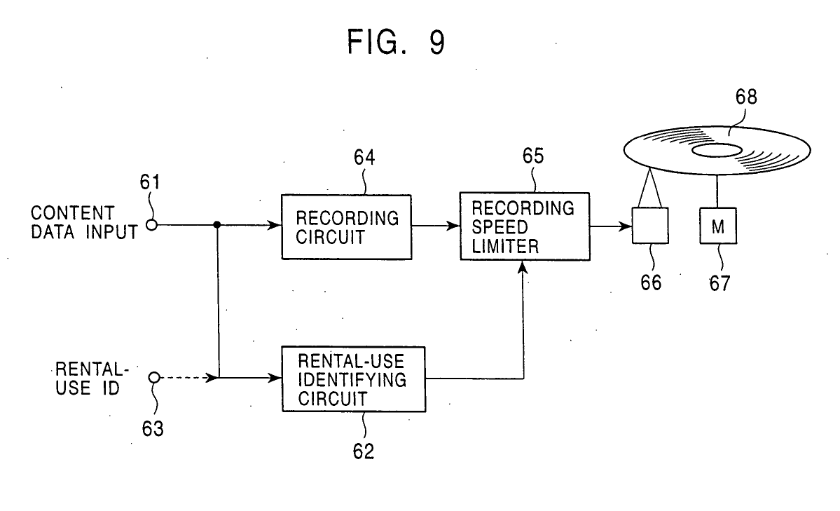

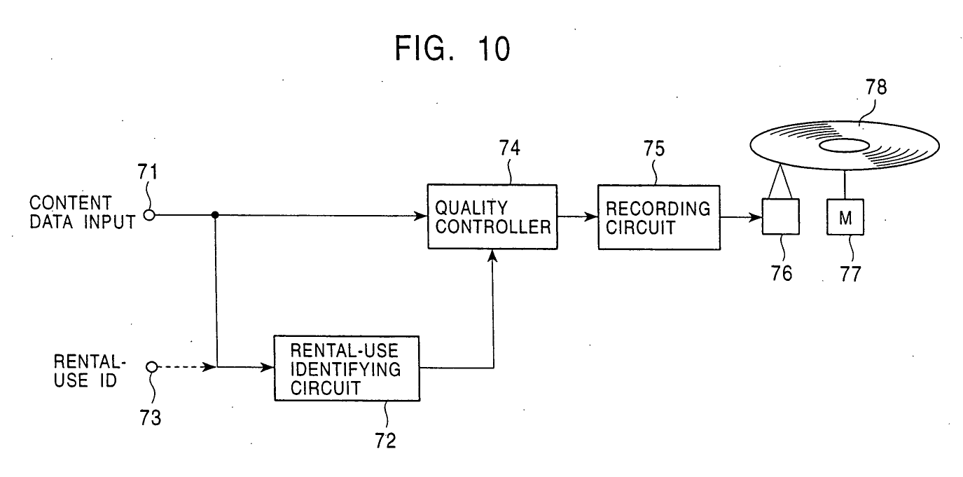

FIG. 9 shows another data copy recording apparatus. This data copy recording apparatus includes a rental-use identifying circuit 62 that determines whether input digital content data is identified as rental-use content data. The identifying result obtained by the rental-use identifying circuit 62 is used to limit a copy recording speed at which digital content data obtained after being recording-processed by a recording circuit (described later) is recorded as a copy. Accordingly, the data copy recording apparatus includes a recording speed limiter 65 for controlling the copy recording speed.

The data copy recording apparatus in FIG. 9 also includes the recording circuit 64 that performs recording processing (such as an encoding process and a modulation process) on content data input from an input terminal 61, an optical head 66 that generates a later beam based on recording data in which the recording speed is limited by the recording speed limiter 65, and a spindle motor 67 that rotates an optical disk 68 at a constant linear or angular velocity. The optical disk 68 is recordable similar to the optical disk 58 in FIG. 8, and may be may be any one of a recordable optical disk such as a CD-R, a phase-change optical disk such as a CD-RW, and other optical disks in accordance with other recording formats.

The operation of the data copy recording apparatus in FIG. 9 is described below.

The rental-use identifying circuit 62 extracts and identifies rental ID data that is added to or superimposed on the content data input from the input terminal 61. When extracting and identifying the rental ID data, the rental-use identifying circuit 62 controls the recording speed limiter 65 to perform limiting processing for the content data output from the recording circuit 64, such as such as limiting the recording speed. The limiting processing performed by the recording speed limiter 65 includes, for example, a process that reduces a data transfer rate.

When the rental-use identifying circuit 62 cannot extract and identify the rental ID data, in other words, when the content data is not for a rental use but for a selling use, the recording speed limiter 65 is controlled not to limit the recording speed so that the input content data is transferred at a standard transfer rate, and the recording circuit 64 performs recording processing, such as encoding processing for modulation and error correcting processes, on the input content data. The processed data is supplied to the optical head 66. As a result, the input content data is recorded as a copy on the optical disk 68.

The rental ID data may be directly supplied from the input terminal 63 to the rental-use identifying circuit 62. The data copy recording apparatus in FIG. 9 uses the recording speed limiter 65 to reduce the recording speed, in other words, to reduce the recording speed than the normal transfer rate used for recording. In addition, also the rotation speed of the optical disk 68 may be reduced than the normal rotation speed in order to perform recording.

Accordingly, for content data having rental ID data added thereto or superimposed thereon, the data copy recording apparatus in FIG. 9 can limit (for example, can reduce) the recording speed to the optical disk 68. This can thus differentiate conducts exceeding private copying.

FIG. 10 shows still another data copy recording apparatus. The data copy recording apparatus in FIG. 10 includes a rental-use identifying circuit 72 that determines whether content data input from an input terminal 71 is identified as rental-use content data. Based on the identifying result obtained by the rental-use identifying circuit 72, the quality of content data to be supplied to a recording circuit 75 (described later) is controlled. Accordingly, the data copy recording apparatus includes a quality controller 74 for controlling the quality of input content data.

The data copy recording apparatus in FIG. 10 also includes the recording circuit 75 that performs recording processing (such as an encoding process and a modulation process) on the content data supplied from the quality controller 74, an optical head 76 that generates a laser beam based on recording data obtained by the recording processing in the recording circuit 75, a spindle motor 77 that rotates an optical disk 78 at a constant linear or angular velocity. The optical disk 78 is recordable similar to the above optical disks 58 and 68.

The operation of the data copy recording apparatus in FIG. 10 is described below.

The rental-use identifying circuit 72 extracts and identifies rental ID data that is added to or superimposed on the content data input from the input terminal 71. When identifying the rental ID data, the rental-use identifying circuit 72 controls the quality controller 74 to perform limiting processing such as lowering of the quality of the input content data. For example, the limiting processing by the quality controller 74 includes, for example, a process for outputting input digital data at a lowered sampling rate, and a process that does not transfer or output lower bits of input digital data.

When the rental-use identifying circuit 72 cannot extract and identifies rental ID data, in other words, when the content data is not for a rental use but for a selling use, the rental-use identifying circuit 72 controls the input content data to be directly supplied to the recording circuit 75, without controlling the quality controller 74 to perform quality control. Data obtained by performing predetermined recording processing such as a modulation process and an error-correcting encoding process is supplied to the optical head 76, so that the input content data is recorded as a copy on the optical disk 78.

The rental ID data may be directly supplied from the input terminal 73 to the rental-use identifying circuit 72.

Accordingly, for content data having rental ID data added thereto or superimposed thereon, the data copy recording apparatus in FIG. 10 can limit the quality of data recorded as a copy on the optical disk 78. This can thus differentiate conducts exceeding private copying.

When each of the above data copy recording apparatuses records a copy of a digital work on an optical disk, a prohibition code, etc., based on the Serial Copy Management System (SCMS) that permits copying in, for example, one generation and prohibits further copying may be recorded in the TOC/lead-in area of the optical disk, or in the data recording area of the optical disk in a form in which it is embedded as a watermark in content data.

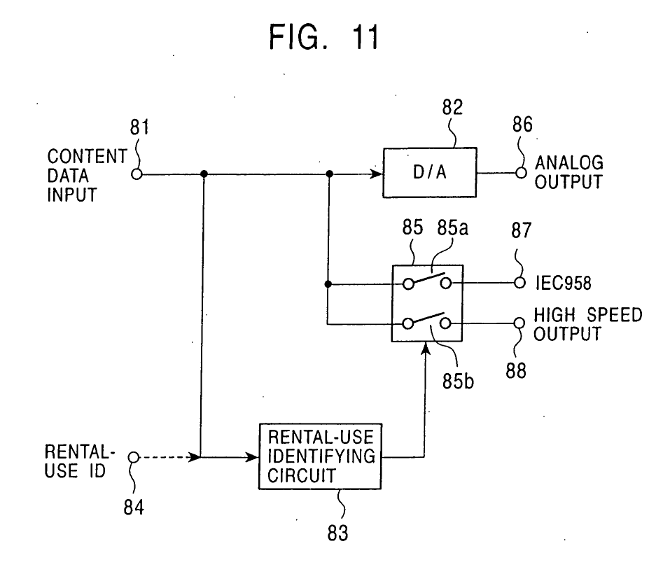

Next, a data output apparatus according to an embodiment of the present invention is described below with reference to FIG. 11.

The data output apparatus in FIG. 11 includes a rental-use identifying circuit 83 that determines whether digital content data input from an input terminal 81 is identified as rental-use content data. Based on the identifying result obtained by the rental-use identifying circuit 83, processing for outputting the input digital content data is restricted. Accordingly, the data output apparatus includes a digital output switching circuit 85 that restricts outputting of the input digital content data. The data output apparatus also includes a digital-to-analog converter 82 that converts the input content data into an analog signal. Irrespective of the identifying result obtained by the rental-use identifying circuit 83, the analog signal generated by converting the content data is always output from an output terminal 86.

The digital output switching circuit 85 includes an upper switch 85a that, based on an identifying-result signal output from the rental-use identifying circuit 83, performs switching for supplying the input content data as output data for IEC958 to an output terminal 87, and a lower switch 85b that, similarly to the upper switch 85a, performs switching for supplying the input content data as high speed output data to an output terminal 88. Output data for use in transmission based on IEEE 1394, USB, or SCSI format is used as the high speed output data.

The operation of the data output apparatus in FIG. 11 is described below.

The rental-use identifying circuit 83 extracts and identifies rental ID data that is added to or superimposed on the content data input from the input terminal 81. When identifying the rental ID data, the rental-use identifying circuit 83 executes control of the digital output switching circuit 85 to turn on or off each of the switches 85a and 85b. For example, if the rental-use identifying circuit 83 is set to output only the analog signal obtained by converting the input content data when identifying the rental ID data, the digital output switching circuit 85 is controlled to turn off both switches 85a and 85b. If the rental-use identifying circuit 83 is set to output also the output data for IEC958 when identifying the rental ID data, the digital output switching circuit 85 is controlled to turn off the lower switch 85b and to turn on the upper switch 85a. When the rental-use identifying circuit 83 cannot extract and identify the rental ID data, it controls the switching circuit 85 to turn on the lower switch 85b and to turn on the upper switch 85a, so that the input content data is output as high speed output data from the output terminal 88. This is because the input content data is identified not as rental-use content data but as selling-use content data.

The rental ID data may be directly supplied from the input terminal 84 to the rental-use identifying circuit 83.

Accordingly, for content data having rental ID data added thereto or superimposed thereon, the data output apparatus can restrict digital output processing, that is, the data output format.

In the above data playback apparatuses and the above data output apparatus, digital content data recorded on a optical disk, or input content data can be identified as one of rental-use content data and selling-use content data. Thus, this enables selling-use content data or digital content data to be played back or output to an external unit from the day the data is purchased. The use of rental-use content data or digital content data may be restricted in playback or outputting to an external unit for a predetermined period from the day the data is purchased. In this case, each apparatus must be provided with a timer for measuring a time or days passing from the day of purchase.

Although the embodiments of the above-described present invention have been described using optical disks, the present invention can be variously modified within a range that does not greatly depart from the gist thereof. For example, in the above-described present invention, an example of an optical disk has been described in which two recording areas consisting of an inner recording area and an outer recording area are used as shown in FIG. 1, and the operation of playing back the outer recording area is restricted. However, the present invention is not limited thereto, but can be applied to a type of optical disk having a single recording area. In this case, for example, by recording rental ID data in the lead-in area of the disk, when the rental ID data is extracted and identified by a playback apparatus in its playback mode, the playback apparatus identifies the disk as rental-use optical disk, and may restrict the operation of playing back data recorded in the recording area of the disk. Needless to say, it is not necessary to restrict the operation of playing back all the pieces of data recorded in the recording area on the optical disk. When pieces of content data are recorded as recorded data, the operation of playing back a specified piece of content data may be restricted. Restriction of the operation of playing back content data may be determined by a copyright holder, a music company, and a medium production company. Although the present invention has been described while using an optical disk as a recording medium, the present invention is not limited to the optical disk but can be applied to various types of recording media such as a semiconductor memory card and an optical-recording-medium card.

What is claimed is:

1.-7. (canceled)

8. A recording medium playback method for playing back a recording medium comprising a first recording area, a second recording area, and a lead-in area in a position being read before said first recording area and said second recording area are read, said recording medium having identification information recorded in at least one of said first recording area, said second recording area, and said lead-in area, the identification information indicating whether or not said recording medium is for a rental use,
said recording medium playback method comprising steps of:
determining whether or not the identification information is extracted and identified from a signal read from said recording medium; and
when the identification information is identified, restricting operation of playing back data which is recorded in at least one of said first recording area and said second recording area;
wherein, when the identification information is identified, the method performs processing for deteriorating a quality of playback data when performing playback processing for the signal read from said recording medium.

9. A recording medium playback method according to claim 8, wherein, when the identification information is identified, the method determines whether or not at least one of said first recording area and said second recording area to be played back is a recording area in which operation of playing back the recording area is restricted by the identification information.

10. (canceled)

11. A recording medium playback method according to claim 9, wherein when the method determines that said at least one recording area to be played back is a recording area other than the recording area in which the operation of playing back the recording area is restricted by the identification information, the operation of normally playing back said recording medium is performed.

12. (canceled)

13. A recording medium playback method according to claim 8, wherein, when the identification information is identified, the method prohibits additional information recorded on said recording medium from being played back.

14. A recording medium playback method according to claim 13, wherein the additional information is recorded in a recording area of which playback is restricted between said first recording area and said second recording area.

15. A recording medium playback method according to claim 8, wherein, when the identification information is not identified, the method performs playing back said first recording area and said second recording area.

16. A recording medium playback apparatus for playing back a recording medium comprising a first recording area, a second recording area, and a lead-in area in a position being read before said first recording area and said second recording area are read, said recording medium having identification information recorded in at least one of said first recording area, said second recording area, and said lead-in area, the identification information indicating whether or not said recording medium is for a rental use,
said recording medium playback apparatus comprising:
a head unit which scans said recording medium;
a decoding processor which performs decoding processing on a signal output from said head unit;
an identifying unit which extracts the identification information from the signal output from said head unit;
a playback processor supplied with data output from said decoding processor, said playback processor performing playback processing on the supplied output data;
a switching unit which is controlled by a signal output from said identifying unit to perform switching as to whether or not the output data from said decoding processor is supplied to said playback processor, said switching unit being controlled, when the identification information is identified by said identifying unit, to supply the output data from said decoding processor to said playback processor; and
a controller supplied with an output signal from the identifying unit, said controller controlling, based on the output signal supplied from the identifying unit, operation of said playback processor, said controller performing, when being supplied with an output signal indicating that the identification information is identified by said identifying unit, restriction of the playback processing by said playback processor on the output data from said decoding processor;
wherein, when the identification information is identified, said controller controls said playback processor to perform data-quality deteriorating processing on the output data from said decoding processor.

17. A recording medium playback apparatus according to claim 16, wherein, when the identification information is identified, said controller determines whether or not at least one of said first recording area and said second recording area to be played back is a recording area in which an operation of playing back the at least one recording area is restricted by the identification information.

18. (canceled)

19. A recording medium playback apparatus according to claim 17, wherein, when said controller determines that said at least one recording area to be played back is a recording area other than a recording area in which the operation of playing back the recording area is restricted by the identification information, said controller controls said playback processor to perform a normal playback operation.

20. (canceled)

21. A recording medium playback apparatus according to claim 16, wherein, when the identification information is identified, said controller prohibits additional information recorded in said recording medium from being played back by said playback processor.

22. A recording medium playback apparatus according to claim 21, wherein the additional information is recorded in at least one recording area of said first recording area and said second recording area in which the identification information restricts the operation of playing back said at least one recording area.

23. A recording medium playback apparatus according to claim 16, further comprising an output terminal supplied with the output data from said decoding processor, wherein, when the identification information is not identified, said identifying unit controls said switching unit to perform switching so that the output data from said decoding processor is supplied to an output terminal.

24.-42. (canceled)
